(19) United States
(12) Patent Application Publication
(10) Pub. No.: US 2012/0053272 A1
(43) Pub. Date: Mar. 1, 2012

(54) POLYIMIDE RESINS FOR HIGH TEMPERATURE WEAR APPLICATIONS

(76) Inventors: Robert Ray Burch, Exton, DE (US); Timothy D. Krizan, Wilmington, DE (US); Jesus G. Moralez, Wilmington, DE (US)

(21) Appl. No.: 13/203,261

(22) PCT Filed: Feb. 25, 2010
(86) PCT No.: PCT/US10/25387

§ 371 Date: Nov. 8, 2011

Related U.S. Application Data
(60) Provisional application No. 61/156,245, filed on Feb. 27, 2009.

(51) Int. Cl. C08K 5/521; H01B 1/20

(52) U.S. Cl. 524/143; 252/511

(57) ABSTRACT

Polyimide resin compositions that contain an aromatic polyimide, graphite, and one or more triaryl phosphates are found to exhibit high wear resistance. Such compositions are especially useful in molded articles that are exposed to wear conditions at high temperatures such as aircraft engine parts.

This application claims priority under 35 U.S.C. §119(e) from, and claims the benefit of, U.S. Provisional Application No. 61/156,245, filed Feb. 27, 2009, which is by this reference incorporated in its entirety as a part hereof for all purposes.

### TECHNICAL FIELD

This disclosure relates to polyimide resins, and filled compositions thereof, that are useful in high temperature applications such as deployment in or as aircraft engine parts.

### BACKGROUND

The unique performance of aromatic polyimide compositions under stress and at high temperatures have made them useful in applications such as for aircraft engine parts, aircraft wear pads, automatic transmission bushings and seal rings, tenter frame pads and bushings, material processing equipment parts, and pump bushings and seals.

Typically, a polyimide component in applications as described above is intended to function as a sacrificial, or consumable, component, thereby preventing or reducing the wear or damage that a more costly mating or adjacent component would experience if it were mated against some other component. As the polyimide component is degraded, however, the resulting increased clearances can result in other adverse effects. These include increased leakage of fluids (such as liquids or gases such as air) with a corresponding drop in pressure, or increased noise; and thereby reduce the operating effectiveness of the entire system in which the polyimide component is contained. Restoring the system to its original operating effectiveness would require replacement of the worn polyimide component with a new, un-used polyimide component. Replacement, however, may require disassembly, reassembly, testing and re-calibration (“service”) of the system, resulting in considerable costs in terms of down-time and labor. Thus, a polyimide component that demonstrates increased high-temperature wear resistance is desirable to reduce the frequency of replacement and service, thereby reducing cost.

U.S. Pat. No. 5,688,848 provides a cross-linked polyimide composition and a polyimide composite useful for making bushings. The composition is obtained by combining a polyimide resin; a reactive plasticizer having at least two four-membered rings which undergo ring scission at an elevated temperature, the plasticizer being added at a level of from 5 to 25 percent by weight based on the total weight of the composition; and a triaryl phosphate, the phosphate being added at a level of from 0.25 to 5 percent by weight based on the total weight of the composition. The composite may contain, for example, (a) a polyimide resin, the polyimide being present at a level from 20 to 90 percent by weight based on the total weight of the composite; (b) a graphite reinforcing fiber, the reinforcing fiber being present at a level of from 10 to 80 percent by weight based on the total weight of the composite; and (c) a triaryl phosphate, the phosphate being present at a level of from 0.1 to 5 percent by weight based on the total weight of the composite.

Despite the variety of polyimide compositions, and additives for those compositions, that have previously been available, a need still remains for polyimide compositions that exhibit a desirable balance of properties, such as the extent of high-temperature wear resistance required when used as a molded part or other article in applications such aircraft engine parts, together with the other advantageous attributes of inherent to a polyimide material.

### SUMMARY

In one embodiment of this invention, there is provided a composition that includes (a) an aromatic polyimide, and (b) a triaryl phosphate (or mixture of triaryl phosphates) that are represented by the structure of the following Formula (I)

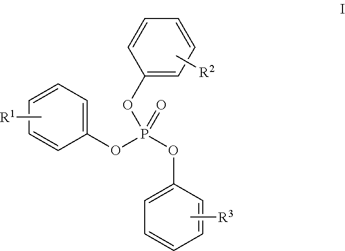

wherein R¹, R² and R³ are each independently H or CH₃.

In another embodiment of this invention, there is provided a method of preparing a composition by admixing (a) an aromatic polyimide with (b) a triaryl phosphate (or mixture of triaryl phosphates) that are represented by the structure of the above described Formula (I), wherein R¹, R² and R³ are each independently H or CH₃, to form the composition.

In a further embodiment of this invention, there is provided a method of fabricating an article by (a) providing a composition that includes (i) an aromatic polyimide, and (ii) a triaryl phosphate (or mixture of triaryl phosphates) that are represented by the structure of the above described Formula (I), wherein R¹, R² and R³ are each independently H or CH₃; and (b) fabricating an article from the composition.

In yet another embodiment of this invention, there is provided a method of increasing the high-temperature wear resistance of an article fabricated from an aromatic polyimide by (a) admixing (i) an aromatic polyimide with (ii) a triaryl phosphate (or mixture of triaryl phosphates) that are represented by the structure of the above described Formula (I), wherein R¹, R² and R³ are each independently H or CH₃, to form a composition thereof; and (b) fabricating the article from the composition.

In yet another embodiment of this invention, any of the compositions prepared or used as described above may optionally contain graphite in addition to an aromatic polyimide and a triaryl phosphate (or mixture thereof).

In yet another embodiment of this invention, any of the compositions prepared or used as described above may have a weight ratio of aromatic polyimide to triaryl phosphate (or mixture of triaryl phosphates) in the range of from about 98:2 to about 87:13. A graphite filler may further be incorporated into such a composition, as described above.

In yet another embodiment of this invention, any of the compositions prepared or used as described above may contain in admixture (a) about 40 weight parts or more and yet about 54 weight parts or less of an aromatic polyimide; and (b) about 0.5 weight parts or more and yet about 20 weight parts or less of a triaryl phosphate (or mixture of triaryl phosphates) that are represented by the structure of the above described Formula (I). A graphite filler may further be incorporated into such a composition, as described above.

Articles fabricated from an aromatic polyimide composition as described above, or fabricated from an aromatic polyimide resin composition produced by a method as described above are also provided.

### DETAILED DESCRIPTION

In one embodiment of this invention, there is provided a composition that includes (a) an aromatic polyimide, and (b) a triaryl phosphate (or mixture of triaryl phosphates) that are represented by the structure of the following Formula (I)

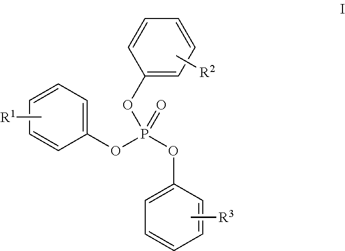

wherein R¹, R² and R³ are each independently H or CH₃.

In another embodiment of this invention, there is provided a method of preparing a composition by admixing (a) an aromatic polyimide with (b) a triaryl phosphate (or mixture of triaryl phosphates) that are represented by the structure of the above described Formula (I), wherein R¹, R² and R³ are each independently H or CH₃, to form the composition.

In a further embodiment of this invention, there is provided a method of fabricating an article by (a) providing a composition that includes (i) an aromatic polyimide, and (ii) a triaryl phosphate (or mixture of triaryl phosphates) that are represented by the structure of the above described Formula (I), wherein R¹, R² and R³ are each independently H or CH₃; and (b) fabricating an article from the composition.

In yet another embodiment of this invention, there is provided a method of increasing the high-temperature wear resistance of an article fabricated from an aromatic polyimide by (a) admixing (i) an aromatic polyimide with (ii) a triaryl phosphate (or mixture of triaryl phosphates) that are represented by the structure of the above described Formula (I), wherein R¹, R² and R³ are each independently H or CH₃, to form a composition thereof; and (b) fabricating the article from the composition.

A polyimide as used herein as the component “(a)” or as the component “(i)”, is a polymer in which at least about 80%, preferably at least about 90%, and more preferably essentially all (e.g., at least about 98%) of the linking groups between repeat units are imide groups. An aromatic polyimide as used herein includes an organic polymer in which about 60 to about 100 mol %, preferably about 70 mol % or more, and more preferably about 80 mol % or more of the repeating units of the polymer chain thereof have a structure as represented by the following Formula (II):

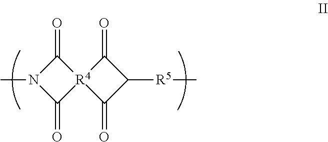

wherein R⁴ is a tetravalent aromatic radical and R⁵ is a divalent aromatic radical, as described below.

A polyimide polymer suitable for use herein may be synthesized, for example, by reacting a monomeric aromatic diamine compound (which includes derivatives thereof) with a monomeric aromatic tetracarboxylic acid compound (which includes derivatives thereof), and the tetracarboxylic acid compound can thus be the tetracarboxylic acid itself, the corresponding dianhydride, or a derivative of the tetracarboxylic acid such as a diester diacid or a diester diacidchloride. The reaction of the aromatic diamine compound with an aromatic tetracarboxylic acid compound produces the corresponding polyamic acid (“PAA”), amic ester, amic acid ester, or other reaction product according to the selection of starting materials. An aromatic diamine is typically polymerized with a dianhydride in preference to a tetracarboxylic acid, and in such a reaction a catalyst is frequently used in addition to a solvent. A nitrogen-containing base, phenol or an amphoteric material can be used as such a catalyst.

A polyamic acid, as a precursor to a polyimide, can be obtained by polymerizing an aromatic diamine compound and an aromatic tetracarboxylic acid compound, preferably in substantially equimolar amounts, in an organic polar solvent that is generally a high-boiling solvent such as pyridine, N-methylpyrrolidone, dimethylacetamide, dimethylformamide or mixtures thereof. The amount of all monomers in the solvent can be in the range of about 5 to about 40 wt %, in the range of about 6 to about 35 wt %, or in the range of about 8 to about 30 wt %, based on the combined weight or monomers and solvent. The temperature for the reaction is generally not higher than about 100° C., and may be in the range of about 10° C. to about 80° C. The time for the polymerization reaction generally is in the range of about 0.2 to about 60 hours.

Imidization to produce the polyimide, i.e. ring closure in the polyamic acid, can then be effected through thermal treatment, chemical dehydration or both, followed by the elimination of a condensate (typically, water or alcohol). For example, ring closure can be effected by a cyclization agent such as pyridine and acetic anhydride, picoline and acetic anhydride, 2,6-lutidine and acetic anhydride, or the like.

In various embodiments of the thus-obtained polyimide, about 60 to 100 mole percent, preferably about 70 mole percent or more, more preferably about 80 mole percent or more, of the repeating units of the polymer chain thereof have a polyimide structure as represented by the structure of the following Formula (II):

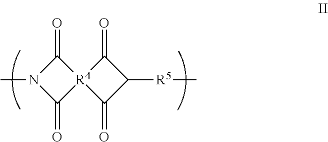

wherein R⁴ is a tetravalent aromatic radical, which can be derived from the tetracarboxylic acid compound; and R⁵ is a divalent aromatic radical, which can be derived from the diamine compound and may typically be represented as H₂N—R⁵—NH₂.

A diamine compound as used to prepare a polyimide for use herein may be one or more of the aromatic diamines that can be represented by the structure H₂N-R⁵—NH₂, wherein R⁵ is a divalent aromatic radical containing up to 16 carbon atoms and, optionally, containing one or more (but typically only one) heteroatoms in the aromatic ring, a heteroatom being, for example, selected from —N—, —O—, or —S—. Also included herein are those R⁵ groups wherein R⁵ is a biphenylene group. Examples of aromatic diamines suitable for use to make a polyimide for a composition hereof include without limitation 2,6-diaminopyridine, 3,5-diaminopyridine, 1,2-diaminobenzene, 1,3-diaminobenzene (also known as m-phenylenediamine or “MPD”), 1,4-diaminobenzene (also known as p-phenylenediamine or “PPD”), 2,6-diaminotoluene, 2,4-diaminotoluene, and benzidines such as benzidine and 3,3′-dimethylbenzidine. The aromatic diamines can be employed singly or in combination. In one embodiment, the aromatic diamine compound is 1,4-diaminobenzene (also known as p-phenylenediamine or “PPD”), 1,3-diaminobenzene (also known as m-phenylenediamine or “MPD”), or mixtures thereof.

Aromatic tetracarboxylic acid compounds suitable for use to prepare a polyimide herein may include without limitation aromatic tetracarboxylic acids, acid anhydrides thereof, salts thereof and esters thereof. Aromatic tetracarboxylic acid compounds suitable for use herein include those that may be represented by the structure of the following Formula (III):

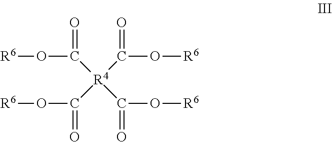

wherein R⁴ is a tetravalent aromatic group and each R⁶ is independently hydrogen or a lower alkyl (e.g. a normal or branched C₁˜C₁₀, C₁˜C₈, C₁˜C₆ or C₁˜C₄) group. In various embodiments, the alkyl group is a C₁ to C₃ alkyl group. In various embodiments, the tetravalent organic group R⁴ may be as represented by the structure of one of the following formulae:

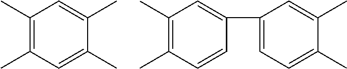

Examples of suitable aromatic tetracarboxylic acids include without limitation 3,3′,4,4′-biphenyltetracarboxylic acid, 2,3,3′,4′-biphenyltetracarboxylic acid, pyromellitic acid, and 3,3′,4,4′-benzophenonetetracarboxylic acid. The aromatic tetracarboxylic acids can be employed singly or in combination. In one embodiment, the aromatic tetracarboxylic acid compound is an aromatic tetracarboxylic dianhydride, particularly 3,3′,4,4′-biphenyltetracarboxylic dianhydride (“BPDA”), pyromellitic dianhydride (“PMDA”), 3,3,4,4′-benzophenonetetracarboxylic dianhydride, or mixtures thereof.

In one embodiment hereof, a suitable polyimide polymer may be prepared from 3,3′,4,4′-biphenyltetracarboxylic dianhydride (“BPDA”) as the aromatic tetracarboxylic acid compound, and from a mixture of greater than about 60 to about 85 mol % p-phenylenediamine (“PPD”) and about 15 to less than about 40 mol % m-phenylenediamine (“MPD”) as the aromatic diamine compound. Such a polyimide is described in U.S. Pat. No. 5,886,129 (which is by this reference incorporated as a part hereof for all purposes), and the repeat unit of such a polyimide may also be represented by the structure of the following Formula (IV):

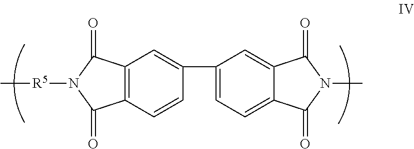

wherein greater than 60 to about 85 mol % of the R⁵ groups are p-phenylene radicals:

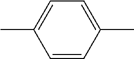

and 15 to less than 40 mol % are m-phenylene radicals:

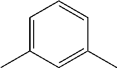

In an alternative embodiment, a suitable polyimide polymer may be prepared from 3,3′,4,4′-biphenyltetracarboxylic dianhydride (“BPDA”) as a dianhydride derivative of the tetracarboxylic acid compound, and 70 mol % p-phenylenediamine and 30 mol % m-phenylenediamine as the diamine compound.

A polyimide as used herein is preferably a rigid polymer. A polyimide polymer is considered rigid when there are no, or an insignificant amount (e.g. less than 10 mol %, less than 5 mol %, less than 1 mol % or less than 0.5 mol %), of flexible linkages in the polyimide repeating unit. Flexible linkages are moieties that are predominantly composed of a small number of atoms, and that have an uncomplicated structure (such as straight-chain rather than branched or cyclic), and thus permit the polymer chain to bend or twist with relative ease at the location of the linkage Examples of flexible linkages include without limitation: —O—, —N(H)—C(O)—, —S—, —SO₂—, —C(O)—, —C(O)—O—, —C(CH₃)₂—, —C(CF₃)₂—, —(CH₂)—, and —NH(CH₃)—. Although disfavored, these or other flexible linkages, when present, are sometimes found in the R⁵ portion of an aromatic diamine compound.

A polyimide as used herein is preferably an infusible polymer, which is a polymer that does not melt (i.e. liquefy or flow) below the temperature at which it decomposes. Typically, articles prepared from a composition of an infusible polyimide are formed under heat and pressure, much like powdered metals are formed into parts [as described, for example, in U.S. Pat. No. 4,360,626 (which is by this reference incorporated as a part hereof for all purposes)].

A polyimide as used herein preferably has a high degree of stability to thermal oxidation. At elevated temperature, the polymer will thus typically not undergo combustion through reaction with an oxidant such as air, but will instead vaporize in a thermolysis reaction.

A triaryl phosphate (or mixture of triaryl phosphates), as used herein as the component “(b)” or the component “(i)”, include those that may be represented by the structure of the following Formula (I):

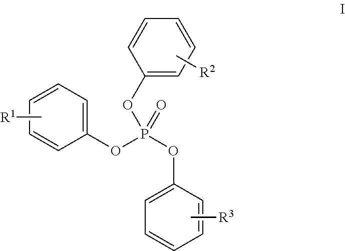

wherein R¹, R² and R³ are each independently H or CH₃. A CH₃ group may be ortho, meta, or para to the oxygen atom. In one embodiment hereof, a triaryl phosphate includes tritolyl phosphate (also known as tricresyl phosphate) in which R¹, R² and R³ are each CH₃. Among suitable isomers of tritolyl phosphate are:

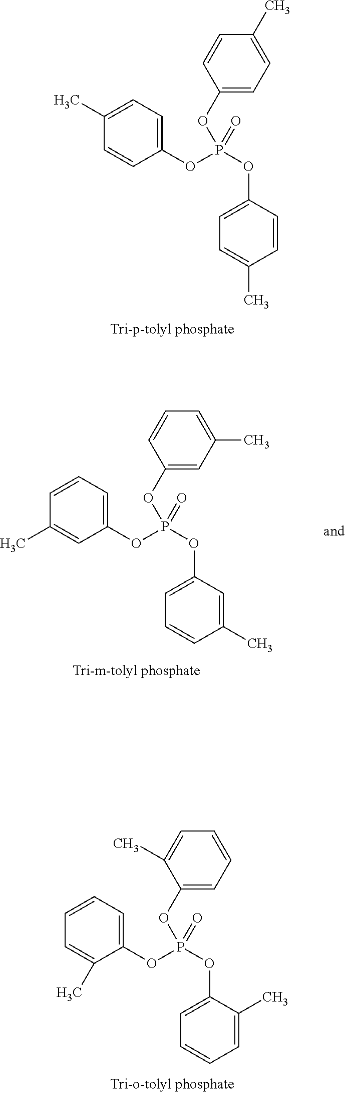

In another embodiment hereof, a triaryl phosphate includes triphenyl phosphate in which R¹, R² and R³ are each H. Triaryl phosphates suitable for use as described herein may be readily obtained from commercial sources.

Graphite can be used as an optional component “(c)”, or an optional component “(iii)”, in a composition hereof. Graphite is typically added to a polyimide composition to improve wear and frictional characteristics, and to control the coefficient of thermal expansion (CTE). The amount of graphite used in a polyimide composition for such purpose is thus sometimes advantageously chosen to match the CTE of the mating components.

Graphite is commercially available in a variety of forms as a fine powder, and may have a widely varying average particle size that is, however, frequently in the range of from about 5 to about 75 microns. In one embodiment, the average particle size of a suitable graphite is in the range of from about 5 to about 25 microns. In another embodiment, graphite as used herein contains less than about 0.15 weight percent of reactive impurities, such as those selected from the group consisting of ferric sulfide, barium sulfide, calcium sulfide, copper sulfide, barium oxide, calcium oxide, and copper oxide.

Graphite as suitable for use herein can be either naturally occurring graphite or synthetic graphite. Natural graphite generally has a wide range of impurity concentrations, while synthetically produced graphite is commercially available having low concentrations of reactive impurities. Graphite containing an unacceptably high concentration of impurities can be purified by any of a variety of known treatments including, for example, chemical treatment with a mineral acid. Treatment of impure graphite with sulfuric, nitric or hydrochloric acid, for example, at elevated or reflux temperatures can be used to reduce impurities to a desired level.

Graphite as used herein is frequently incorporated into the heated solvent prior to transfer of a PAA polymer solution (or other solution for other types of monomers) as described above, which causes the resulting polyimide to be precipitated in the presence of the graphite, which thereby becomes incorporated into the composition formed thereby.

In one embodiment of the compositions of this invention, the content of the various components therein includes all of the possible ranges that may be formed from the following amounts of those components:
component (a), an aromatic polyimide, may be present in an amount of about 40 weight parts or more, about 42 weight parts or more, about 44 weight parts or more or about 46 weight parts or more, and yet in an amount of about 54 weight parts or less, about 52 weight parts or less, about 50 weight parts or less or about 48 weight parts or less;
component (b), a triaryl phosphate (or mixture of triaryl phosphates) as represented by the structure of Formula I, may be present in an amount of about 0.5 weight parts or more, about 1.5 weight parts or more, about 3 weight parts or more, or about 6 weight parts or more, and yet in an amount of about 20 weight parts or less, about 18 weight parts or less, about 12 weight parts or less, or about 9 weight parts or less; and
component (c), an optional graphite, when present, may be present in an amount of about 46 weight parts or more, about 48 weight parts or more, about 50 weight parts or more or about 52 weight parts or more, and yet in an amount of about 60 weight parts or less, about 58 weight parts or less, about 56 weight parts or less or about 54 weight parts or less.
   In the compositions hereof, the amounts of the respective weight parts of the two (or, optionally, three) components described above as admixed or combined together in any particular formulation, taken from the ranges as set forth above, may or may not total to 100 weight parts. The compositions of this invention thus include all of the formulations in which the compositional content may be expressed by any combination of the various maxima and minima, as set forth above, for any one component of the composition together with any such combination of maxima and minima for either or both of the other two components.

In another embodiment of the compositions of this invention, the content of the polyimide and triaryl phosphate therein includes all of the possible ranges that may be formed from the following amounts of those components:
component (a), an aromatic polyimide, may be present in an amount of about 87 wt % or more, about 90 wt % or more, or about 93 wt % or more, and yet in an amount of about 98 wt % or less, about 97 wt % or less, or about 96 wt % or less; and
component (b), a triaryl phosphate (or mixture of triaryl phosphates) as represented by the structure of Formula I, may be present in an amount of about 2 wt % or more, about 3 wt % or more, or about 4 wt % or more, and yet in an amount of about 13 wt % or less, about 10 wt % or less, or about 7 wt % or less.
   In the compositions hereof, the content weight percents of the two components described above are expressed as a percent of the total weight of the polyimide and triaryl phosphate as mixed together to form a composition. The compositions of this invention thus include all of the formulations in which the compositional content may be expressed by any combination of the various wt % maxima and minima, as set forth above, for any one of those two components together with any such combination of wt % maxima and minima for the other component.

A composition formed from an aromatic polyimide and a triaryl phosphate (or mixture of triaryl phosphates) in the weight percentage amounts as set forth above may contain graphite as an optional third component. When graphite is present in the composition, the content of the graphite can be in an amount of about 40 wt % or more, or about 45 wt % or more, and yet in an amount of about 60 wt % or less, or about 55 wt % or less, of the total of the weight of the whole (three-component) composition, with the balance of the weight of the whole composition formed thereby being made up of the mixture of an aromatic polyimide with a triaryl phosphate (or mixture of triaryl phosphates). In the balance of the composition, as made up of the polyimide and triaryl phosphate, the content allocation as between those two components can follow the wt % ranges for them set forth above.

Combining an aromatic polyimide with a triaryl phosphate (or mixture of triaryl phosphates), as described herein, provides a polyimide composition that has increased high-temperature wear resistance as compared to the same polyimide in the absence of a triaryl phosphate. An intimate mixture of the components may be formed by any method known in the art that is convenient, depending on the nature of the triaryl phosphate (or mixture of triaryl phosphates) used. For example, whether the phosphate is liquid or solid under mixing conditions will affect the choice of method. One method of forming a suitably intimate mixture comprises dissolving the triaryl phosphate (or mixture of triaryl phosphates) in a solvent, such as acetone, to form a solution; mixing the solution with the desired aromatic polyimide in the form of a powder (for example, as a slurry in acetone); and then removing the solvent by any convenient means such as evaporation. The resulting compositional mixture can then be formed into articles such as parts, or combined with additional materials and then formed into articles.

A graphite-filled polyimide composition having increased high-temperature wear resistance may be prepared in an analogous manner, i.e. by mixing a solution (e.g. in acetone) of a triaryl phosphate (or mixture of triaryl phosphates) with a slurry of a mixture of graphite and aromatic polyimide (e.g. in acetone), and then removing the solvent by any convenient means such as evaporation.

One or more additives may be used as an optional component “(d)” in a composition hereof. When used, additive(s) may be used in an amount in the range of about 5 to about 70 wt % based on the total weight of all three components together in a 3-component [(a)+(b)+(d)] composition, with the total weight of the other two components together [(a)+(b)] being in the range of about 30 to about 95 wt % based on the total weight of all three components together in a 3-component [(a)+(b)+(d)] composition. Alternatively, when both graphite and additives are used, additive(s) may be used in an amount in the range of about 5 to about 70 wt % based on the total weight of all four components together in a 4-component [(a)+(b)+(c)+(d)] composition, with the total weight of the other three components together [(a)+(b)+(c)] being in the range of about 30 to about 95 wt % based on the total weight of all four components together in a 4-component [(a)+(b)+(c)+(d)] composition.

Additives suitable for optional use in a composition hereof may include, without limitation, one or more of the following: pigments; antioxidants; materials to impart a lowered coefficient of thermal expansion, e.g., carbon fibers; materials to impart high strength properties, e.g., glass fibers, ceramic fibers, boron fibers, glass beads, whiskers, graphite whiskers or diamond powders; materials to impart heat dissipation or heat resistance properties, e.g., aramid fibers, metal fibers, ceramic fibers, whiskers, silica, silicon carbide, silicon oxide, alumina, magnesium powder or titanium powder; materials to impart corona resistance, e.g., natural mica, synthetic mica or alumina; materials to impart electric conductivity, e.g., carbon black, silver powder, copper powder, aluminum powder or nickel powder; materials to further reduce wear or coefficient of friction, e.g., boron nitride or poly(tetrafluoroethylene) homopolymer and copolymers. Fillers may be added as dry powders to the final resin prior to parts fabrication.

Materials suitable for use in or to make a composition hereof may themselves be made by processes known in the art, or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

As with products made from other infusible polymeric materials, parts or other articles fabricated from a composition hereof may be made by techniques involving the application of heat and pressure (see, for example, U.S. Pat. No. 4,360,626). Suitable conditions may include, for example, pressures in the range of from about from 50,000 to 100,000 psi (345 to 690 MPa) at ambient temperatures. Physical properties of articles molded from a composition hereof can be further improved by sintering, which may typically be performed at a temperature in the range of from about 300° C. to about 450° C.

Parts and other articles prepared from a composition hereof are useful as aircraft engine parts such as bushings, bearings, washers, seal rings, gaskets, wear pads and slide blocks. These parts may be used in all types of aircraft engines such as reciprocating piston engines and, particularly, jet engines. Parts and other articles prepared from a composition hereof are also useful in the following: automotive and other types of internal combustion engines; other vehicular subsystems such as exhaust gas recycle systems and clutch systems; pumps; non-aircraft jet engines; turbochargers; aircraft subsystems such as thrust reversers, nacelles, flaps systems and valves; materials processing equipment such as injection molding machines; material handling equipment such as conveyors, belt presses and tenter frames; and films, seals, washers, bearings, bushings, gaskets, wear pads, seal rings, slide blocks and push pins and other applications where low wear is desirable. In some applications, a part or other article prepared from a composition hereof is in contact with metal at least part of the time when the apparatus in which it resides is assembled and in normal use.

### EXAMPLES

The advantageous attributes and effects of the compositions hereof may be seen in a series of examples (Examples 1˜5), as described below. The embodiments of these compositions on which the examples are based are representative only, and the selection of those embodiments to illustrate the invention does not indicate that materials, components, reactants, ingredients, formulations or specifications not described in these examples are not suitable for practicing the inventions herein, or that subject matter not described in these examples is excluded from the scope of the appended claims and equivalents thereof.

In the examples, the following abbreviations are used: “BPDA” is defined as 3,3′,4,4′-biphenyltetracarboxylic anhydride, “MPD” is defined as m-phenylenediamine, “PPD” is defined as p-phenylenediamine, “PMDA” is defined as pyromellitic dianhydride, “ODA” is defined as oxydianiline, “mL” is defined as milliliter(s), “cm” is defined as centimeter(s), “in” is defined as inch, “g” is defined as gram(s), and “wt %” is defined as weight percent(age).

### Materials.

3, 3′, 4, 4′-biphenyltetracarboxylic anhydride was obtained from Mitsubishi Gas Chemical Co., Inc. (Tokyo, Japan). Pyromellitic dianhydride and oxydianiline were used as obtained from their respective suppliers. M-phenylenediamine and p-phenylenediamine were obtained from DuPont (Wilmington Del., USA). The graphite used was a synthetic graphite, maximum 0.05% ash, with a median particle size of about 8 microns. The tritolyl phosphate used was a mixture of ortho, meta, and para isomers, 90% purity, CAS Registry Number 1330-78-5, and was obtained from Sigma-Aldrich (St. Louis Mo.). Triisopropyl phosphate, 97% purity, was obtained from Sigma-Aldrich (St. Louis Mo.).

### Wear Tests.

Dried polyimide resin was fabricated into disks 2.5 cm in diameter and about 0.5 cm thick by direct forming, using a procedure substantially according to the procedure described in U.S. Pat. No. 4,360,626 (especially column 2, lines 54-60), which patent is by this reference incorporated in its entirety as a part hereof for all purposes.

High temperature wear on the disks was measured at 800° F. (427° C.). In these tests, a steel ball bearing was rubbed against the surface of a test specimen, oscillating at 300 cycles/minute under a 2 pound load for a 3 hour period. At the end of the experiment, the volume of the resulting wear scar on the test specimen (“Resin Wear”) was measured by optical profilometry, from which the volume of the wear scar may be determined. The result for Resin Wear is reported as the volume of weight lost, stated in in³ or cm³. Measurements were made using the test procedures described in ASTM G 133-05 (2005), “Standard Test Method for Linearly Reciprocating Ball-on-Flat Sliding Wear”, modified by using a temperature controlled oven, with acquisition of friction force data on a computer.

### Example 1

### Preparation and Wear of a BPDA-MPD/PPD Polyimide Resin Containing Tritolyl Phosphate

Polyimide resin based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129, which is by this reference incorporated in its entirety as a part hereof for all purposes. After drying, the resin was ground through a 20 mesh screen using a Wiley mill to form a powder (Resin 1A).

1.514 g tritolyl phosphate and 100 mL acetone were combined and then magnetically stirred for one hour. The resulting solution was added to vigorously stirring slurry of 75.60 g of the polyimide powder in acetone. Total solvent volume was 600 mL. After stirring for a minimum of 17 hours, the solvent was removed under vacuum to yield a powdery solid (Resin 1B) containing the tritolyl phosphate at a loading of 1.96 wt %. The procedure was repeated but using 3.782 g tritolyl phosphate, yielding a powdery solid.

The wear rates of the resulting resins as determined by ASTM G133 are given in Table 1.

TABLE 1

| | | | Wear volume, |
|---|---|---|---|
| | | Additive | 10⁻⁸ in³ |
| Resin | Additive | wt % | (10⁻⁷ cm³) |
| 1A | none | 0 | 3500 (5735) |
| 1B | tritolyl phosphate, 90% | 1.96 | 1128 (1848) |
| | mixture isomers | | |
| 1C | tritolyl phosphate, 90% | 4.90 | 718 (1177) |
| | mixture isomers | | |

### Example 2

### Preparation and Wear of a Polyimide Resin Containing Triphenyl Phosphate

Polyimide resin based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129. After drying, the resin was ground through a 20 mesh screen using a Wiley mill to form a powder.

2.5 g triphenyl phosphate and 100 mL acetone were combined and then magnetically stirred for one hour. The resulting solution was added to vigorously stirring slurry of 50 g of the polyimide powder in acetone. Total solvent volume was 400 mL. After stirring for 24 hours, the solvent was removed under vacuum to yield a powdery solid containing the triphenyl phosphate at a loading of 4.76 wt %.

The wear rate of the resulting resin as determined by ASTM G133 was 333 10⁻⁸ in³ (546 10⁻⁷ cm³), while the wear rate of the same polyimide resin in the absence of triphenyl phosphate was 3500 10⁻⁸ in³ (5735 10⁻⁷ cm³).

### Comparative Example A

### Preparation and Wear of a BPDA-MPD/PPD Polyimide Resin Containing Triisopropyl Phosphate

Polyimide resin based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129. After drying, the resin was ground through a 20 mesh screen using a Wiley mill to form a powder.

2.5 g triisopropyl phosphate and 100 mL acetone were combined and then magnetically stirred for one hour. The resulting solution was added to vigorously stirring slurry of 50.0 g of the polyimide powder in acetone. Total solvent volume was 500 mL. After stirring for 20 hours, the solvent was removed under vacuum to yield a powdery solid containing the triisopropyl phosphate at a loading of 4.76 wt %.

The wear rate of the resulting resin as determined by ASTM G133 was 6560 10⁻⁸ in³ (10750 10⁻⁷ cm³), while the wear rate of the polyimide resin in the absence of triisoproyl phosphate was 3500 10⁻⁸ in³ (5735 10⁻⁷ cm³).

### Example 3

### Preparation of a PMDA-ODA Polyimide Resin Containing Tritolyl Phosphate

Polyimide resin based on pyromellitic dianhydride (PMDA) and oxydianiline (ODA) was prepared according to the method described in U.S. Patent Publication 2007/0021547, which is by this reference incorporated in its entirety as a part hereof for all purposes. After drying, the resin was ground through a 20 mesh screen using a Wiley mill to form a powder.

0.026 g tritolyl phosphate and a suitable quantity of acetone were combined and then magnetically stirred for 0.5 hour. The resulting solution was added to vigorously stirring slurry of 0.50 g of the polyimide powder in acetone. Total solvent volume was 25 mL. After stirring for 21.5 hours, the solvent was removed under vacuum to yield a powdery solid containing the tritolyl phosphate at a loading of 4.94 wt %.

The wear rate of the resulting resin as determined by ASTM G133 was 1650 10⁻⁸ in³(2704 10⁻⁷ cm³), while the wear rate of the same polyimide resin in the absence of tritolyl phosphate was 6765 10⁻⁸ in³ (11086 10⁻⁷ cm³).

### Example 4

### Preparation and Wear of a Filled BPDA-MPD/PPD Polyimide Resin Containing Tritolyl Phosphate

Particles of a polyimide/graphite resin based on 3,3′,4,4′-biphenyltetracarboxylic dianhydride (BPDA), m-phenylene diamine (MPD) and p-phenylene diamine (PPD) containing 50 wt % graphite were prepared according to the method described in U.S. Pat. No. 5,886,129. After drying, the resin was ground through a 20 mesh screen using a Wiley mill to form a powder (Resin 4A).

1.0 gram of tritolyl phosphate and 100 mL acetone were combined and then magnetically stirred for one hour. The solution was added to a vigorously stirring slurry of 50 g of the polyimide/graphite powder in acetone. Total solvent volume was 350 mL. After stirring for 16 hours, the solvent was removed under vacuum to yield a powdery solid containing the tritolyl phosphate at a loading of 3.84 wt %, based on the weight of tritolyl phosphate plus polyimide polymer, or 1.96 wt % based on the total composition (polyimide polymer, graphite, and tritolyl phosphate)(Resin 4B). The procedure was repeated but using 2.949 g tritolyl phosphate, 50.5 g of the polyimide/graphite powder, and stirring the mixture for 19 hours. The resulting powdery solid (Resin 1C) with a tritolyl phosphate loading of 10.5 wt % based on the weight of tritolyl phosphate plus polyimide polymer, or 5.52 wt % based on the total composition (Resin 4C).

The wear rates of the resulting resins as determined by ASTM G133 are given in Table 2.

TABLE 2

| | 50:50 | | | |
|---|---|---|---|---|
| | Polyimide/ | Tritolyl phosphate, 90% | | |
| | Graphite | mixture isomers, wt % | | Wear volume, |
| | Resin | Based on polyimide | Based on Total | 10⁻⁸ in³ |
| Resin | (g) | polymer + additive | composition | (10⁻⁷ cm³) |
| 4A | | 0 | 0 | 2200 (3605) |
| 4B | 50 | 3.84 | 1.96 | 1333 (2184) |
| 4C | 50.5 | 10.5 | 5.52 | 310 (508) |

### Example 5

### Preparation of a Filled BPDA-MPD/PPD Polyimide Resin Containing Triphenyl Phosphate

Particles of a polyimide/graphite resin based on 3,3′,4,4′-biphenyltetracarboxylic dianhydride (BPDA), m-phenylene diamine (MPD) and p-phenylene diamine (PPD) containing 50 wt % graphite were prepared according to the method described in U.S. Pat. No. 5,886,129. After drying, the resin was ground through a 20 mesh screen using a Wiley mill to form a powder.

2.5 gram of triphenyl phosphate and 100 mL acetone were combined and then magnetically stirred for one hour. The solution was added to a vigorously stirred slurry of 50 g of the polyimide/graphite powder in acetone. Total solvent volume was 400 mL. After stirring for 23 hours, the solvent was removed under vacuum to yield a powdery solid containing the triphenyl phosphate at a loading of 9.09 wt %, based on the weight of triphenyl phosphate plus polyimide polymer, or 4.76 wt % based on the total composition (polyimide polymer, graphite, and triphenyl phosphate).

The wear rate of the resulting resin as determined by ASTM G133 was 1372 10⁻⁸ in³ (2248 10⁻⁷ cm³), while the wear rate of the same polyimide resin in the absence of triphenyl phosphate was 2200 10⁻⁸ in³ (3605 10⁻⁷ cm³).

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

Where a range of numerical values is recited herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage,
(a) amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value;
(b) all numerical quantities of parts, percentage or ratio are given as parts, percentage or ratio by weight;
(c) use of the indefinite article “a” or “an” with respect to a statement or description of the presence of an element or feature of this invention, does not limit the presence of the element or feature to one in number; and
(d) the words “include”, “includes” and “including” are to be read and interpreted as if they were followed by the phrase “without limitation” if in fact that is not the case.

What is claimed is:

1. A method of preparing a composition comprising admixing (a) an aromatic polyimide with (b) a triaryl phosphate (or mixture of triaryl phosphates) that are represented by the structure of the following Formula (I), 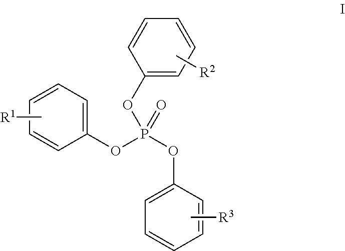
wherein R¹, R² and R³ are each independently H or CH₃, to form the composition.

2. A method according to claim 1 further comprising admixing the aromatic polyimide with graphite.

3. A method according to claim 2 wherein the composition comprises in admixture (a) about 40 weight parts or more and yet about 54 weight parts or less of an aromatic polyimide; (b) about 0.5 weight parts or more and yet about 20 weight parts or less of a triaryl phosphate (or mixture of triaryl phosphates); and (c) about 46 weight parts or more and yet about 60 weight parts or less graphite.

4. A method according to claim 1 wherein the polyimide is prepared from an aromatic tetracarboxylic acid compound or derivative thereof, wherein the aromatic tetracarboxylic acid compound is represented by the structure of the following Formula (III): 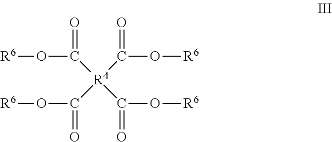
wherein R⁴ is a tetravalent aromatic group, and each R⁶ is independently hydrogen or a C₁˜C₁₀ alkyl group, or mixtures thereof.

5. A method according to claim 1 wherein the polyimide is prepared from an aromatic tetracarboxylic acid compound selected from the group consisting of 3,3′,4,4′-biphenyltetracarboxylic acid, 2,3,3′,4′-biphenyltetracarboxylic acid, pyromellitic acid, and 3,3′,4,4′-benzophenonetetracarboxylic acid, or derivative thereof, or mixtures thereof.

6. A method according to claim 1 wherein the polyimide is prepared from a diamine compound represented by the structure H₂N—R⁵—NH₂, wherein R⁵ is a divalent aromatic radical containing up to 16 carbon atoms and, optionally, containing in the aromatic ring one or more heteroatoms selected from the group consisting of —N—, —O—, and —S—.

7. A method according to claim 1 wherein the polyimide is prepared from a diamine compound selected from the group consisting of 2,6-diaminopyridine, 3,5-diaminopyridine, 1,2-diaminobenzene, 1,3-diaminobenzene, 1,4-diaminobenzene, 2,6-diaminotoluene, 2,4-diaminotoluene, benzidine and 3,3′-dimethylbenzidine.

8. A method according to claim 1 wherein the polyimide comprises the recurring unit 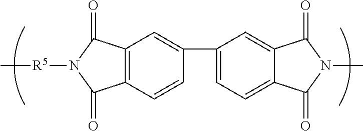
wherein R⁵ is selected from the group consisting of p-phenylene radicals, 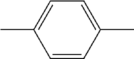
m-phenylene radicals, 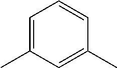
and a mixture thereof.

9. A method according to claim 8 wherein greater than 60 to about 85 mol % of the R⁵ groups comprise
p-phenylene radicals, and about 15 to less than 40 mol % comprise m-phenylene radicals.

10. A method according to claim 8 wherein about 70 mol % of the R⁵ groups comprise p-phenylene radicals and about 30 mol % of the R⁵ groups comprise m-phenylene radicals.

11. A method according to claim 3 wherein the composition comprises in admixture (a) about 46 weight parts or more and yet about 52 weight parts or less of an aromatic polyimide, (b) about 3 weight parts or more and yet about 12 weight parts or less of the triaryl phosphate (or mixture of triaryl phosphates), and (c) about 48 weight parts or more and yet about 54 weight parts or less graphite.

12. A method according to claim 1 wherein the traryl phosphate is tri-p-tolyl phosphate, tri-m-tolyl phosphate, tri-o-tolyl phosphate, triphenyl phosphate, or a mixture of any two or more of these.

13. A method according to claim 3 wherein the composition further comprises in admixture as a component (d) one or more additives in an amount in the range of about 5 to about 70 wt % based on the weight of the total [(a)+(b)+(c)+(d)] composition, with the combined weight of the (a)+(b)+(c) components being together in the range of about 30 to about 95 wt % of the total composition.

14. A method according to claim 13 wherein an additive comprises one or more members of the group consisting of pigments; antioxidants; materials to impart a lowered coefficient of thermal expansion; materials to impart high strength properties; materials to impart heat dissipation or heat resistance properties; materials to impart corona resistance; materials to impart electric conductivity; and materials to reduce wear or coefficient of friction.

15. An article fabricated from a composition produced according to claim 1.

16. An article according to claim 15 which comprises an internal combustion engine part.

17. An article according to claim 15 which comprises an aircraft part or an automotive part.

18. An article according to claim 15 which comprises a bushing, bearing, washer, seal ring, wear pad or slide block.

19. An article according to claim 15 which comprises a part for a gas recycle system; a clutch system; a pump; a turbocharger; a thrust reverser, a nacelle, a flaps system; an injection molding machine; a conveyor, belt press; and a tenter frame.

20. A composition of matter comprising (a) an aromatic polyimide, and (b) a triaryl phosphate (or mixture of triaryl phosphates) as represented by the structure of the following Formula (I) 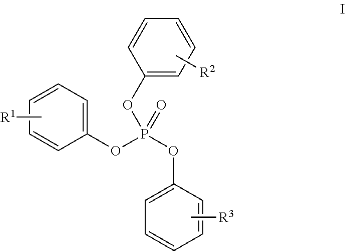
wherein R¹, R² and R³ are each independently H or CH₃.
